(19) United States
(12) Patent Application Publication
(10) Pub. No.: US 2026/0051102 A1
(43) Pub. Date: Feb. 19, 2026

(54) AUGMENTED MASS-SPRING SYSTEM FOR DIGITAL HAIR SIMULATION

(71) Applicant: Adobe Inc., San Jose, CA (US)

(72) Inventors: Yi Zhou, San Jose, CA (US); Zhixin Shu, San Jose, CA (US); Xin Sun, Palo Alto, CA (US); Jorge Alejandro Amador Herrera, Mexico City (MX)

(73) Assignee: Adobe Inc., San Jose, CA (US)

(21) Appl. No.: 18/808,930

(22) Filed: Aug. 19, 2024

(51) Int. Cl. G06T 13/40; G06T 13/60

(52) U.S. Cl. CPC G06T 13/40; G06T 13/60

(57) ABSTRACT

In implementations of techniques and systems for digital hair simulation using an augmented mass-spring model, a processing device receives a hair model including multiple hair strands and a head geometry. Each hair strand is discretized into multiple particles connected by multiple first springs. The processing device also defines a rest configuration for each hair strand with ghost positions corresponding to the position of the multiple particles in the rest configuration. Each particle is connected to the rest configuration by second springs. The processing device then simulates the movement of the hair strands in response to an input action using the first and second springs. The simulated movement is presented via a display device.

### BACKGROUND

Simulating realistic digital hair models is important for various applications, such as creating videos with digital humans. Despite advancements in digital capture and generative systems, simulating high-quality three-dimensional (3D) hair models remains challenging due to the intricate structure and dynamic behavior of hair. Some conventional techniques to capture hair dynamics, including body and self-collisions, have employed mass-spring systems to simulate hair dynamics. These conventional mass-spring techniques, however, struggle to simulate global material stiffness, resulting in extreme sagging, violation of inextensibility constraints (e.g., unrealistic hair lengthening), and the loss of hair structure during simulation. These issues are particularly prominent with highly stylized hairstyles. Other conventional approaches address the sagging issue, but are much more computationally expensive, hindering the interactive simulation of thousands of hair strands.

### SUMMARY

Techniques and systems for an augmented mass-spring system for digital hair simulation are described. In one example, a processing device receives a hair model with multiple hair strands representing a digital hairstyle. Each hair strand is discretized into multiple particles connected by multiple first springs. The processing device also defines a rest or initial configuration for each hair strand with ghost positions corresponding to the discretized particles. Each particle is connected to the rest configuration using second springs. The processing device then simulates, using the first and second springs, the movement of the hair strands in response to an input action (e.g., head movement, wind blowing). The simulated movement is presented to a user via a display device.

This Summary introduces a simplified selection of concepts that are further described below in the Detailed Description. As such, this Summary is not intended to identify essential features of the claimed subject matter or to aid in determining its scope.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 illustrates a digital medium environment in an example implementation that is operable to employ an augmented mass-spring system for digital hair simulation techniques as described herein.

FIG. 2 depicts a system in an example implementation that shows the operation of a hair simulation service of FIG. 1 in greater detail as employing the techniques described herein.

FIG. 3 illustrates an example discretization of a hair strand for the augmented mass-spring system as described herein.

FIG. 4 is a flow diagram depicting an algorithm as a step-by-step procedure in an example implementation of operations performable for simulating digital hair dynamics using an augmented mass-spring model.

FIG. 5 depicts multiple example implementations for simulating digital hair dynamics using a conventional mass-spring system and the described augmented mass-spring system.

FIG. 6 is a flow diagram depicting an algorithm as a step-by-step procedure in an example implementation of operations performable for accomplishing digital hair simulation using an augmented mass-spring system.

FIG. 7 illustrates an example system including various components of an example device that can be implemented as any type of computing device as described and/or utilized with reference to the previous figures to implement embodiments of the techniques described herein.

### DETAILED DESCRIPTION

### Overview

The movie industry and the visual effects community employ hair modeling to create lifelike digital humans. Despite advancements in high-end capture systems, simulating the dynamics of high-quality hair models, including body and self-collisions, remains difficult due to hair's intricate structure and dynamic behavior.

One conventional technique involves mass-spring systems. Despite being able to simulate vivid behavior, these conventional mass-spring systems typically require additional two-way coupled sets of springs and particles to maintain system stability. Additionally, these methods struggle to simulate overall material stiffness, leading to excessive hair drooping, unnatural hair lengthening or stretching, and the loss of a hairstyle's overall shape.

Other conventional approaches use discrete elastic rods or position-based Cosserat rods to address the challenges faced by conventional mass-spring systems. These rod methods employ more physically accurate models to achieve greater realism. However, due to their increased complexity, these conventional rod systems also require the use of more intensive computational resources and specialized integration routines to ensure interactive times and eliminate sagging effects.

In contrast, the systems and techniques described herein introduce an augmented mass-spring model for real-time simulation of digital hair at the strand level. The system considers the traditional edge, bending, and torsional degrees of freedom in mass-spring systems, but adds a one-way biphasic coupling with a ghost rest-shape configuration. The described techniques improve system stability, provide pseudo-stiffness to prevent sagging effects, preserve global hair geometry, and simulate non-Hookean effects during intense hair motion. In other words, these techniques offer the efficiency advantages of mass-spring systems over more complex hair models (e.g., conventional Cosserat rod models), enabling robust simulation of multiple hair configurations (e.g., facial hair). Additionally, the described framework enables real-time generation and editing of simulation-ready hair.

Mass-spring models used for hair simulation generally discretize each strand into particles connected by springs that provide edge, bending, and torsion degrees of freedom. Some conventional mass-spring models introduce additional ghost particles and springs, as well as an altitude spring, to prevent issues such as ill-defined torsion springs and collapsed tetrahedrons formed by consecutive particles. While efficiently reproducing realistic hair dynamics, this conventional approach requires highly stiff springs to maintain global stability, preserve hair shape, and reduce individual strand jittering.

The above problems arise from the complex interaction between the hair particles and two-way coupled ghost particles, as well as the linearly increasing weight each particle has to support from root to tip. To address these issues, the described augmented mass-spring system uses the edge, bending, and torsion springs along with one-way stiffness springs to connect each particle interaction with its corresponding ghost position in the rest configuration. Unlike conventional mass-spring systems requiring 2N−1 coupled particles, the described augmented mass-spring system uses just the original N particles, making it a more memory-efficient model.

In an example implementation, a processing device receives a hair model with multiple hair strands representing a digital hairstyle. The processing device discretizes each hair strand of the multiple hair strands into multiple particles connected by multiple first springs to provide edge, bending, and torsion degrees of freedom. A rest or initial configuration is also defined for each hair strand with ghost positions corresponding to the initial position of discretized particles. Each particle is connected to the rest configuration by second springs. The processing device then simulates, using the first and second springs, the movement of the hair strands in response to an input action (e.g., head movement, wind blowing). In this way, the described techniques enable real-time generation and editing of simulation-ready hair assets.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Digital Hair Generation Environment

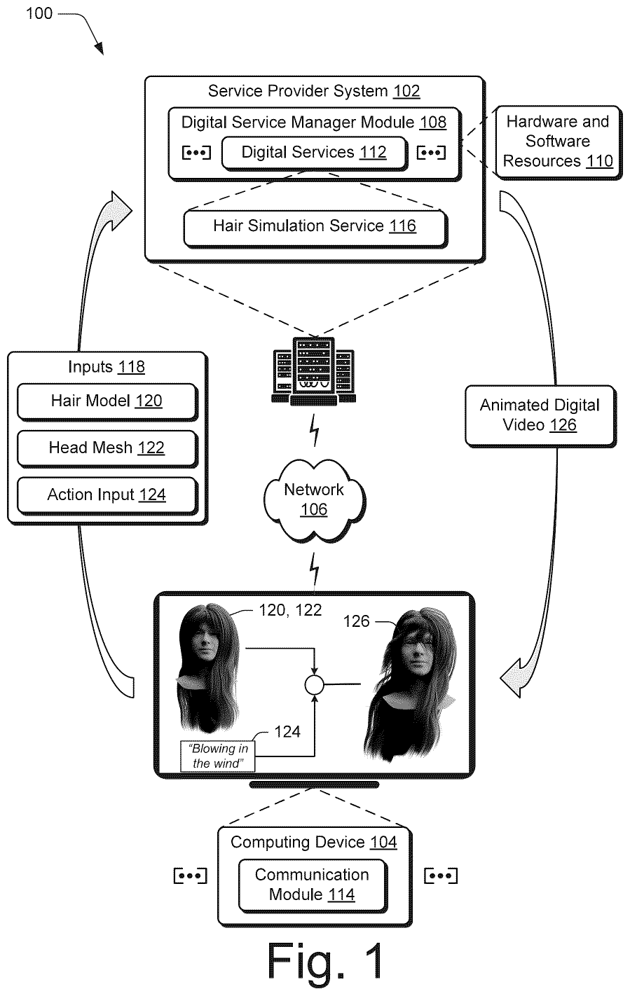

FIG. 1 illustrates a digital medium environment 100 in an example implementation that is operable to employ an augmented mass-spring system for simulation techniques of digital hair as described herein. The illustrated digital medium environment 100 includes a service provider system 102 and a computing device 104 that are communicatively coupled, one to another, via a network 106. Computing systems for the service provider system 102 and the computing device 104 are configurable in a variety of ways. For instance, computing device 104 is associated with a user, and service provider system 102 is a remote computing system (e.g., one or more servers) configured to employ the described techniques and systems for simulating digital hair.

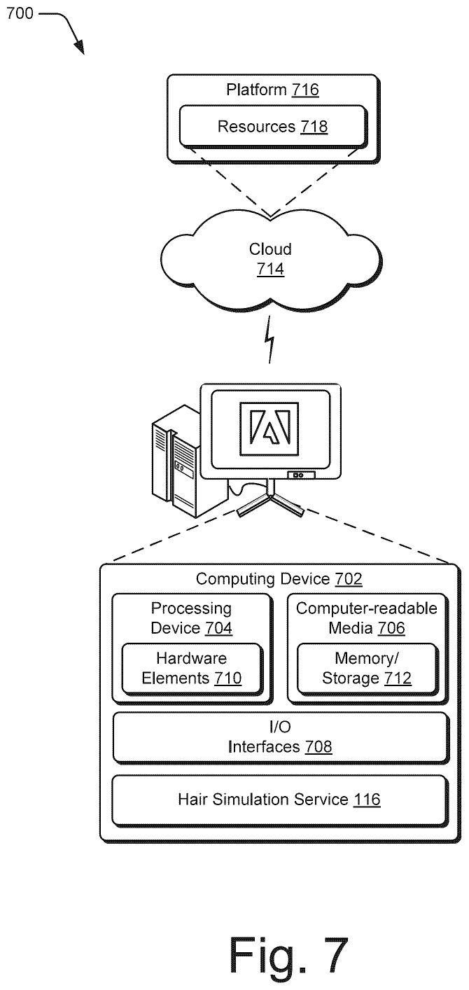

A computing system, for instance, is configurable as a desktop computer, laptop computer, mobile device (e.g., assuming a handheld configuration such as a tablet or mobile phone), server, and so forth. Thus, the service provider system 102 or the computing device 104 is capable of ranging from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described in relation to FIG. 7.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a hair simulation service 116 for simulating different interactions and grooming scenarios with digital 3D hair. Although illustrated as implemented remotely by the service provider system 102, functionality of the hair simulation service 116 is also configurable for implementation locally, e.g., as part of the communication module 114 at the computing device 104.

To simulate digital hair, the hair simulation service 116 processes inputs 118 to generate an animated digital video 126. The inputs 118 include a hair model 120, a head mesh 122, and an action input 124. The hair model 120 provides a strand representation of the hairstyle to be animated, while the head mesh 122 represents the head's geometry associated with the hairstyle. The action input 124 indicates the motion or interactions to be simulated.

The described hair simulation service 116 leverages an augmented mass-spring model for real-time hair simulation at the strand level of different hairstyles (including facial hair), complex hair-solid interactions, and external user inputs. Similar to conventional mass-spring models, the augmented mass-spring model considers edge, bending, and torsional degrees of freedom, but an additional one-way biphasic coupling with a ghost rest shape is employed. The biphasic coupling improves the stability of the described augmented mass-spring system and provides stiffness that alleviates sagging effects, preserves the global hair geometry, and enables the simulation of non-Hookean effects during intense hair motion. As a result, given an input hair model 120, the hair simulation service 116 enables the consistent generation of synthetic data during real-time editing sessions, including action inputs 124 of procedural growth, trimming at different directions and altitudes, input wind, and head motion.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Hair Generation Using a Parametric Model

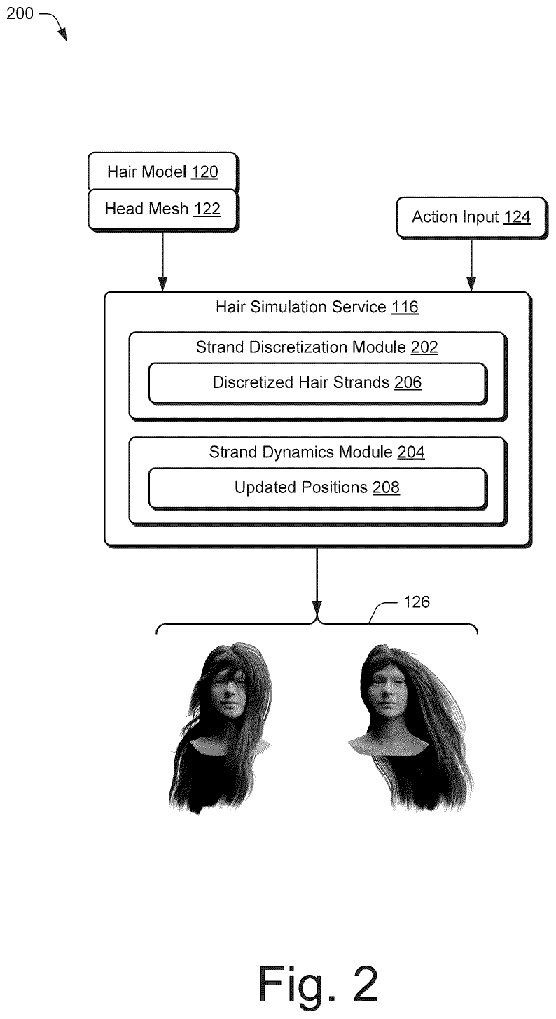

FIG. 2 depicts a system 200 in an example implementation showing the operation of the hair simulation service 116 of FIG. 1 as employing the techniques described herein. The hair simulation service 116 includes a strand discretization module 202 and a strand dynamics module 204. As described above, the hair simulation service 116 receives the hair model 120, head mesh 122, and action input 124 as inputs and outputs the animated digital video 126 providing realistic hair simulation.

### Strand Discretization

The strand discretization module 202 discretizes each hair strand of the hair model 120 as particles with a series of springs to generate discretized hair strands 206. The discretization reduces the computation cost to simulate the individual hair strands by reducing the number of underlying calculations. In addition, the discretization allows the hair simulation service 116 to utilize various numerical methods to model the different interactions.

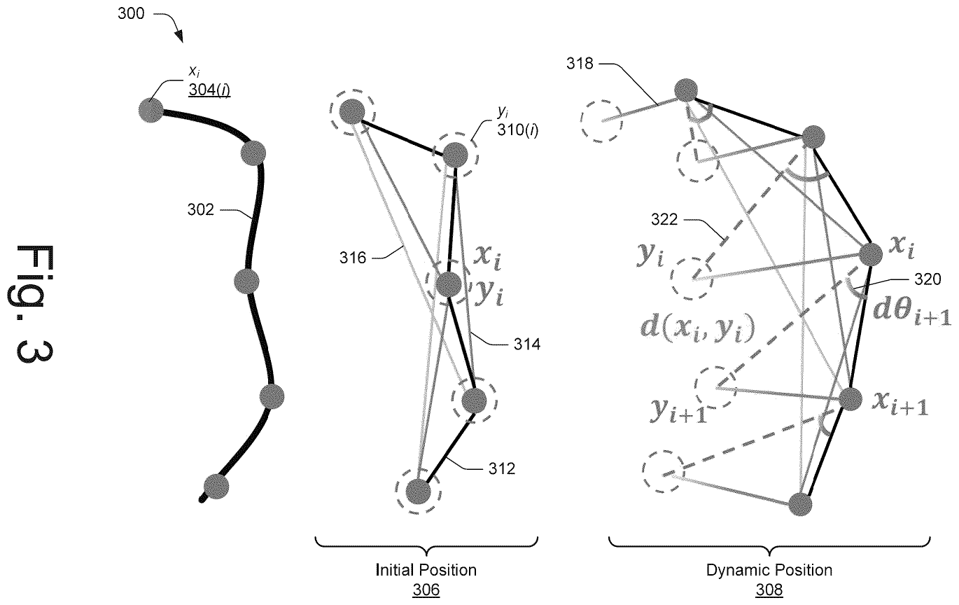

FIG. 3 illustrates an example 300 of a hair strand 302 discretized for the augmented mass-spring system as described herein. In this example, the hair strand 302 is discretized into five particles 304 (also called real particles), with each particle 304(i) represented by xᵢ. The number N of particles 304 is five in example 300. In other implementations, N is equal to a different number (e.g. usually fifteen to twenty particles). In contrast, some conventional mass-spring systems require 2N−1 coupled particles (e.g., nine as opposed to five in example 300) by introducing ghost particles, making the augmented mass-spring system more efficient in terms of memory because a matrix with about half the size is solved during each iteration.

In a general mass-spring model, each hair strand is discretized as particles connected with springs that provide edge, bending, and torsion degrees of freedom. Conventional mass-spring approaches introduce a set of additional ghost particles, ghost springs, and an altitude spring to prevent ill-defined torsion springs and collapsed tetrahedrons formed by consecutive particles. While being able to reproduce vivid hair dynamics, these conventional models usually require highly stiff springs to maintain global solution stability, preserve the local hair shape, and reduce the jittering of individual strands. These difficulties arise mostly from the intricate interaction of hair particles with two-way coupled ghost particles (e.g., the ghost and real particles affect each other) and the linearly increasing weight each real particle supports (from the tip to the root of a strand).

The augmented mass-spring model uses the basic edge springs 312, bending springs 314, and torsion springs 316. The edge springs 312 connect adjacent particles of each discretized hair strand 302. The bending springs 314 connect particles separated by a single particle along each hair strand, while the torsional springs 316 connect particles separated by two particles along each hair strand.

In lieu of ghost particles and an altitude spring, the described augmented mass-spring model uses one-way stiffness springs (318, 322) to provide an interaction with a ghost rest shape (e.g., as illustrated by an initial position 306). The one-way stiffness springs connect each particle 304(i) (in a dynamic position 308) with its corresponding ghost 310(i), represented by yᵢ, in the initial position 306. The ghost rest shape is unidirectionally coupled to the rest of the system using biphasic springs of zero rest length.

Specifically, given a discretized hair strand 302 containing N particles with positions x₀, . . . , x_{N-1}, the model defines yᵢ as the position of the ghost 310(i) corresponding to the ith particle 304(i). The first part of the interaction uses a rest or gravity spring 318 with zero rest length and tension T_{g} computed as:

$${T}_{g} = {κ}_{g} d ( {x}_{i} , {y}_{i} ) , \qquad ( 1 )$$

where κ_{g} is the spring constant, and d: [symbol] ³× [symbol] ³→ [symbol] ³ is the distance function between two vectors (e.g., the distance between the position of a real particle 304(i) and its corresponding ghost 310(i)). This rest spring 318 connects each particle 304 to its corresponding ghost 310 configuration. Moreover, at initialization, xᵢ=yᵢ,∀iϵ{1, . . . , N}.

The described augmented spring-mass model also introduces an angular spring 322 so that, if dθᵢ₊₁ is the angle 320 between segments xᵢyᵢ₊₁ and xᵢxᵢ₊₁, then the tension of the angular spring T_{α} is given by:

$${T}_{α} = {κ}_{α} d {θ}_{i + 1} , \qquad ( 2 )$$

where the angular spring 322 connects the (i+1)th particle to its ghost. At initialization, each edge is aligned to the ghost counterpart, so that dθᵢ₊₁=0 ∀iϵ{1, . . . , N}.

Each pair of springs between ghost and real particles act in a biphasic fashion, i.e., they are connected in parallel, with an effective total spring constant of κ_{T}=κ_{g}+κ_{α}. The interaction between the ghost and real particles is one-way; in other words, the real particles do not affect the ghost particles, greatly improving computation and memory efficiency.

### Strand Dynamics

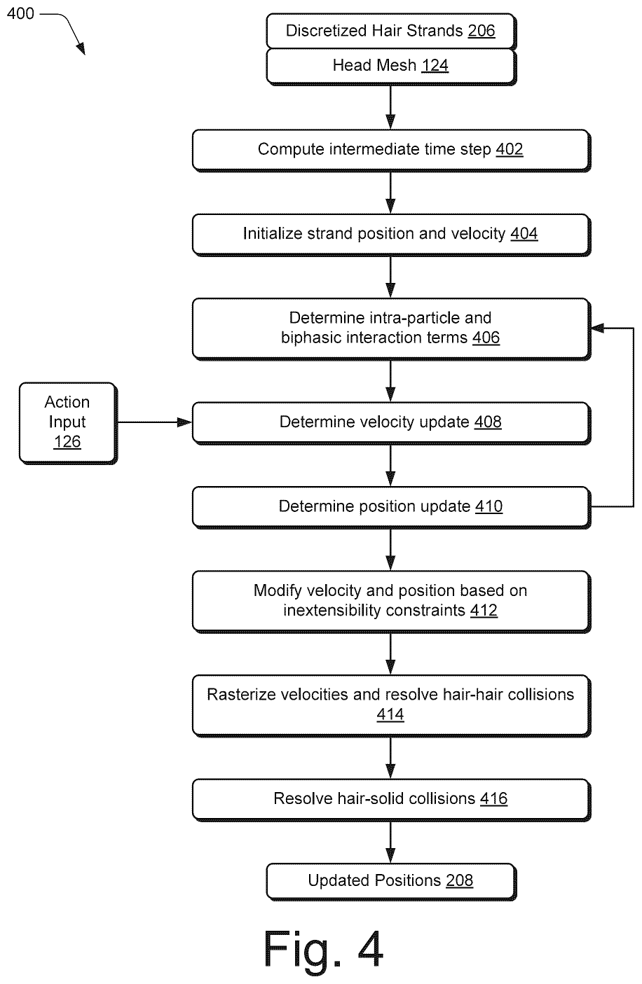

The strand dynamics module 204 takes input positions of the strands (e.g., as defined by the hair model 120), as well as the action input 124, and determines updated positions 208 for each particle of the discretized hair strands 206. In particular, the strand dynamics module 204 uses the augmented mass-spring model to provide a real-time simulation of a hair model at the strand level. After determining the biphasic interaction terms from the one-way springs and the inter-particle spring terms, the strand dynamics module 204 determines an initial updated position of each particle and models the strand interactions and hair collisions to generate the updated positions 208 at each iteration, as described in greater detail with respect to FIG. 4.

FIG. 4 is a flow diagram depicting an algorithm 400 as a step-by-step procedure in an example implementation of operations performable for simulating digital hair dynamics using an augmented mass-spring model. In particular, the strand dynamics module 204 uses the algorithm 400 to determine the updated positions 208 for each hair strand based on the action input 124. The initial inputs to algorithm 400 include the discretized hair strands 206 and the head mesh 122.

Letting

$${x}_{i}^{n} , {y}_{i}^{n} , {ν}_{i}^{n} , and {w}_{i}^{n}$$

denote the position of each real-ghost pair of particles and their corresponding velocities. The superscripts denote the current time step. The vectors Xⁿ, Yⁿ, Vⁿ, Wⁿ ϵ [symbol] ^{3N} hold the position and velocities of the complete real-ghost strand pair. Using this notation, the backward Euler equations from time tⁿ to tⁿ⁺¹ are written as:

$${X}^{n + 1} = {X}^{n} + Δ t {V}^{n + 1} , \qquad ( 3 )$$

$${V}^{n + 1} = {V}^{n} + Δ t {M}^{- 1} ( {F}^{n} + {S}^{n + 1} - G {V}^{n + 1} ) , \qquad ( 4 )$$

where Δt=tⁿ⁺¹−tⁿ, M, Gϵ [symbol] ^{3N×3N} are the mass and damping coefficient matrix, respectively; the matrices Fⁿ, Sⁿ⁺¹ϵ [symbol] ^{3N×3N} on the other hand, denote the total external and internal forces. In particular, each entry

$${s}_{i}^{n + 1}$$

of

$${S}^{n + 1}$$

is computed as:

$${s}_{i}^{n + 1} = {\sum }_{j ∈ 𝒩 ( i )} {κ}_{i , j} ( {( {x}_{j}^{n + 1} - {x}_{i}^{n + 1} )}^{⊤} {\hat{d}}_{i , j}^{n + 1} - {l}_{i , j} ) {\hat{d}}_{i , j}^{n + 1} , \qquad ( 5 )$$

where the stiffness κ_{i,j} and rest-length l_{i,j} characterize the spring connecting particles i and j, the set [symbol] contains each particle connected to i, and the normalized direction vector is computed as:

$${\hat{d}}_{i , j}^{n + 1} = \frac{{x}_{j}^{n + 1} - {x}_{i}^{n + 1}}{‖ {x}_{j}^{n + 1} - {x}_{i}^{n + 1} ‖} .$$

The strand dynamics module 204 begins by computing an intermediate time step Δ\acute{t} for each iteration (block 402), where Δ\acute{t}=Δt/INT and INT represents the number of intermediate steps for each iteration. The strand dynamics module 204 also initializes the position and velocity of each strand (block 404). The initialized position and velocity are defined as

$${X}_{0}^{n + 1} = {X}^{n} and {V}_{0}^{n + 1} = {V}^{n} .$$

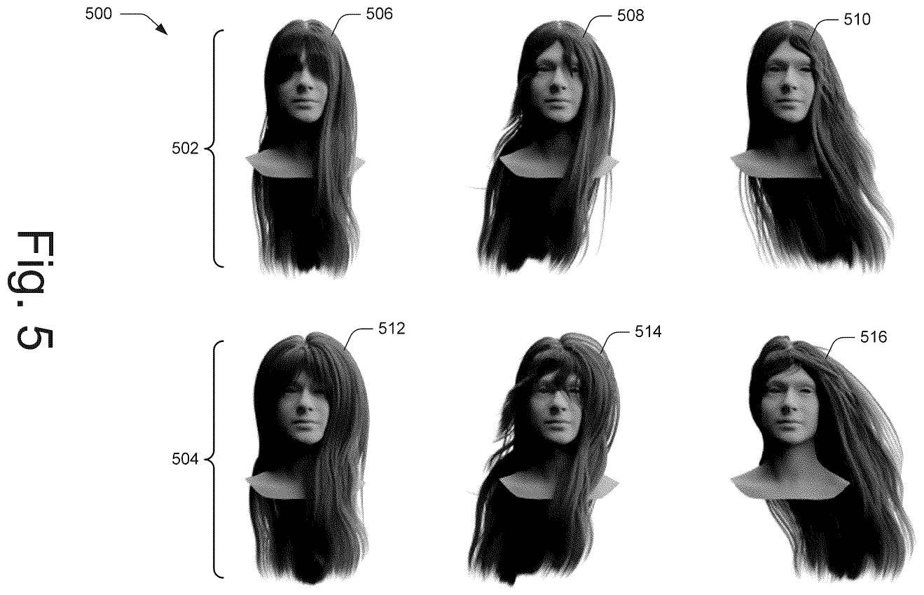

In traditional mass-spring systems, the edge, bending, and torsional degrees of freedom help preserve the local features of strands. However, these conventional models do not include information about global features encoded in the model, which causes intense sag at initialization and loss of non-local hair structures (as illustrated in FIG. 5).

In contrast, the biphasic interaction of the augmented mass-spring model serves as this encoding via the gravity and angular springs. In particular, while the angular interaction improves the system's stability, the gravity part of the coupling acts as an effective pseudo-stiffness as it prevents global deformation with respect to the initial configuration. Using dimensional analysis and parameter tuning, the physical material stiffness E_{b} of a strand is directly related to the gravity spring via E_{b}=λ_{b}κ̅_̅{̅b̅}̅, where κ̅_̅{̅g̅}̅=m⁻¹ is the average gravity constant of the particles in the strand, and λ_{b}≈16.45 Mm⁻¹ (found via parameter tuning). Moreover, better results are obtained when setting linearly decreasing values of κ as a function of the initial particle distance from the root.

The hair simulation service 116 uses a technique analogous to gravity pre-loading to address a small sagging effect at initialization. At initialization, each strand spring (e.g., edge, bending, and torsion springs), as well as biphasic terms (e.g., gravity and angular springs), are at equilibrium, so the force acting on each particle is due to its own weight w=mg. As a result, the initial sag stops when the spring forces reach a new equilibrium with the total hair weight. In addition, the input configuration gives each internal degree of freedom and angular interaction, which then evolves dynamically. An equilibrium is achieved without sagging by pre-processing the gravitational part of the interaction κ_{g} in terms of the ghost configuration

To accomplish this, the hair simulation service 116 considers each particle i with position xᵢ and its corresponding ghost at the position yᵢ=xᵢ+Δrᵢ, where Δrᵢ is the vector joining both particles. Δrᵢ=0 at initialization. This value is pre-processed to account for sagging by setting:

$${T}_{g} - {w}_{i} = 0 , \qquad ( 6 )$$

where T_{g} is the gravity term of the biphasic interaction. Using Equation (1), this is rewritten as:

$${κ}_{g} d ( {x}_{i} , {y}_{i} ) {\hat{r}}_{i} - {w}_{i} = {κ}_{g} ‖ {Δr}_{i} ‖ {\hat{r}}_{i} - {w}_{i} = 0. \qquad ( 7 )$$

Solving Equation (7) element-wise, the hair simulation service 116 obtains:

$$Δ {r}_{i} = \frac{m}{{κ}_{g}} g . \qquad ( 8 )$$

Setting the initial position of ghost particles to yᵢ=xᵢ+Δrᵢ, enables the hair simulation service 116 to eliminate sagging at initialization.

The strand dynamics module 204 then iterates through the intermediate time steps (int) to determine the updated velocity and position for the hair strands. In particular, the iterations start at the first intermediate time step (int=1) until the next time step is reached (int≤INT). At each intermediate time step, the strand dynamics module 204 determines the intra-particle and biphasic interaction terms (block 406).

For the biphasic interaction, κ_{i,j}=κ_{τ}, and l_{i,j}=0. Linearization is utilized by keeping the direction vector fixed so that \hat{d}ⁿ⁺¹→\hat{d}ⁿ and the internal force terms become:

$${s}_{i}^{n + 1} = {\sum }_{j ∈ 𝒩 ( i )} {κ}_{i , j} ( ‖ {x}_{j}^{n + 1} - {x}_{i}^{n + 1} ‖ - {l}_{i , j} ) {\hat{d}}_{i , j}^{n} + {\sum }_{j ∈ 𝒩 ( i )} {κ}_{i , j} Δ t {D}_{i , j}^{n} ( {v}_{j}^{n + 1} - {v}_{i}^{n + 1} ) {\hat{d}}_{i , j}^{n} , \qquad ( 9 )$$

where

$${D}_{i , j}^{n} = {( {\hat{d}}^{n} )}^{T}$$

\hat{d}ⁿ is the direction matrix for particles i and j. The first term in this expansion corresponds to the explicitly integrated elastic force, while the second term describes the damping of the spring, fixed at κ_{i,j}Δt, to ensure stability in the semi-implicit discretization.

Given the expansion in Equation (9), the internal force vector is written as:

$${S}^{n + 1} = {\hat{S}}^{n} + Δ {tC}^{n} {V}^{n + 1} \qquad ( 10 )$$

where Ŝⁿ is the elastic term at t=n, and the connectivity matrix Cⁿϵ [symbol] ^{3N×3N} is composed of block matrices cⁿϵ [symbol] ^{3×3}, computed as:

$${c}_{i , j}^{n} = \{ \begin{matrix}{κ}_{i , j} {D}_{i , j}^{n} , & j ∈ 𝒩 ( i ) , \\ - {\sum }_{j ∈ 𝒩 ( i )} {κ}_{i , j} {D}_{i , j}^{n} , & i = j , \\ 0 ∈ {ℝ}^{3 \times 3} , & else .\end{matrix} \qquad ( 11 )$$

Because the rigid-body ghost configuration is one-way coupled with the real particles 304, the ghost interaction is included in the elastic term Ŝⁿ and by adding the velocity term separated as the external interaction

$${κ}_{τ} Δ t {D}_{g , i}^{n} {w}_{i}^{n + 1}$$

and the damping

$$- {κ}_{τ} {D}_{g , i}^{n} {v}_{i}^{n + 1} ,$$

where the ghost direction matrix

$${D}_{g , i}^{n}$$

is defined as:

$${D}_{g , i}^{n} = \{ \begin{matrix}{( {\hat{d}}_{g , i} )}^{T} {\hat{d}}_{g , i} & ‖ {x}_{i}^{n} - {y}_{i}^{n} ‖ \neq 0 , \\ 0 ∈ {ℝ}^{3 \times 3} & else .\end{matrix} \qquad ( 12 )$$

The separation of ghost terms allows computation of first the ghost rigid-body dynamics and then updating of the real strand dynamics using an N×N matrix, as opposed to a (2N−1)×(2N−1) matrix in a two-way coupled system. Combining all the interaction terms, the implicit Euler step ε is expressed as:

$$( I + Δ {tM}^{- 1} G - Δ {t}^{2} {M}^{- 1} {C}^{n} ) {V}^{n + 1} = {V}^{n} + Δ {tM}^{- 1} ( {F}^{n} + {\hat{S}}^{n} ) .$$

Because the interactions are localized between neighboring particles, the resulting system is a strictly heptadiagonal banded matrix, which can be solved efficiently using diverse sparse solvers.

The strand dynamics module 204 then determines a velocity update for the intermediate time step (block 408). The action input 124 is provided as an input to determine the total external force Fⁿ on the hair strands. In particular, the strand dynamics module 204 solves the implicit Euler step to determine the velocity updated given by

$${V}_{i n t}^{n + 1} = ε \cdot ( {X}_{i n t - 1}^{n + 1} , {V}_{i n t - 1}^{n + 1} , {F}^{n} , Δ {t}^{′} ) .$$

For the hybrid Eulerian/Lagrangian scheme, the strand dynamics module 204 embeds the head mesh 122 S within two 3D volumes Ω_{Int,SDF}ϵ [symbol] ³, which are used for hair-hair interactions and signed distance function (SDF) information, respectively. Because the resulting numerical system is heptadiagonal, the LU decomposition is solved exactly using two iterations. In general, the implicit system for a strand has the form AV=b, where the biphasic interaction is incorporated into b, and, considering the edge, bending, and torsional degrees of freedom, the only non-zero elements in row i are those at j=i−3, . . . , i+3. The system is then written as:

$${A}_{i , j} = \{ \begin{matrix}- Δ {t}^{2} {M}_{i}^{- 1} {κ}_{i , j} {D}_{i , j} , & \vert i - j \vert \leq 3 , \\ ( 1 + Δ t {M}_{i}^{- 1} {G}_{i} ) I + {\sum }_{j ∈ 𝒩 ( i )} Δ {t}^{2} {M}_{i} {κ}_{i , k} {D}_{i , k} , & i = j , \\ 0 , & else ,\end{matrix}$$

$${b}_{i} = {V}_{i}^{n} Δ t {M}_{i}^{- 1} ( {F}^{n} + {\hat{S}}^{n} )$$

This represents a linear equation in [symbol] ³ and is solved using a single forward and backward pair of sweeps. The first sweep corresponds to the decomposition A=LU, where the strict band size of A implies that L_{i,j}=U_{i,j}=0 for i−j<3 and j−i>3, respectively. For the other entries in the decomposition, the forward sweep is performed first to compute:

$${L}_{i , j} = {A}_{i , j} - {\sum }_{k = max ( 1 , i - 3 )}^{j - 1} {L}_{i , k} {U}_{k , j} ,$$

$${{V}^{′}}_{i} = {( {L}_{i , i} )}^{- 1} [ {b}_{i} - {\sum }_{j = max ( 0 , i - 3 )}^{i - 1} {L}_{i , j} {{v}^{′}}_{j} ] ,$$

with the intermediate vector \acute{V}=L⁻¹b. Next the backward sweep yields:

$${U}_{i , j} = {( {L}_{i , i} )}^{- 1} [ {A}_{i , j} - {\sum }_{k = max ( 1 , j - 3 )}^{i - 1} {L}_{i , k} {U}_{k , j} ] ,$$

$${V}_{i} = {{V}^{′}}_{i} - {\sum }_{j = i + 1}^{min ( i + 3 , N )} {U}_{i , j} {V}_{j} ,$$

where the final vector V is given by the relation UV=\acute{V}, and satisfies the original equation because:

$$AV = L ( UV ) = L {V}^{´} = L ( {L}^{- 1} b ) = b . \qquad ( 13 )$$

The strand dynamics module 204 then determines a position update for the intermediate time step (block 410). In particular, the strand dynamics module 204 determines the updated position given by

$${X}_{int}^{n + 1} = {X}_{int - 1}^{n + 1} + Δ {t}^{´} {v}_{int}^{n + 1} .$$

Blocks 406 through 410 are repeated until the loop variable int equals the number of intermediate time steps M.

### Inextensibility Preservation

The strand dynamics module 204 then modifies the updated velocity

$${V}_{INT}^{n + 1}$$

and position

$${X}_{INT}^{n + 1}$$

based on inextensibility constraints (block 412). The inextensibility constraints limit the hair strands to prevent them from stretching or compressing (e.g., changing in length). The inextensibility can be enforced through either constrained dynamic techniques or post-integration corrections. In one implementation, the strand dynamics module 204 adopts the post-integration approach, where inextensibility is enforced by projecting over-stretched segments. Specifically, two strand sweeps are implemented to enforce inextensibility.

### Hair Interactions

The strand dynamics module 204 rasterizes the modified velocities, resolves hair-hair collisions, and further modifies for volume preservation and viscosity (block 414). Self-interactions and collisions with solids are important components to provide realistic hair simulation. Multiple approaches for handling complex interactions include adaptive non-linearity treatment and skinning formulation. Generally, these techniques are tailored for specific strand models.

The strand dynamics module 204 implements a two-stage hybrid Eulerian/Lagrangian approach because the Lagrangian particle system of the described augmented mass-spring system fits naturally into these schemes. In the first stage, the strand dynamics module 204 treats hair geometry in a continuum matter, while the second segment-wise collision treatment is used for maintaining details for collisions.

The strand dynamics module 204 starts by discretizing the hair geometry as a set of particles with radius r₀ and unit mass. Then, incompressibility is enforced by using density constraints Cᵢ for particle i, defined as:

$${C}_{i} = {( {γ}_{0} )}^{3} W ( {p}_{i} - {p}_{j} , h ) , \qquad ( 14 )$$

with filter kernel W, kernel radius h, and neighboring particle set [symbol] . Then, the update in positions is given by the sum of contributions for each constraint Cᵢ=0 with a single Newton iteration:

$$\frac{- Δ {x}_{i}}{∇ W ( {p}_{i} - {p}_{j} , h ) {γ}_{0}^{3}} = ( \frac{{C}_{i}}{{‖ ∇ {C}_{i} ‖}^{2} + ϵ} + \frac{{C}_{j}}{{‖ ∇ {C}_{j} ‖}^{2} - ϵ} + {s}_{corr} ) ,$$

where ϵ and s_{corr} are terms used to avoid gradient and tensile instabilities, respectively. Finally, the clumping is tuned by modifying the velocity with the smoothing kernel:

$${{v}^{´}}_{i} = {v}_{i} + v ( {v}_{j} - {v}_{i} ) W ( {p}_{j} - {p}_{i} , h ) , \qquad ( 15 )$$

with viscosity coefficient ν.

The second collision-detection state uses an impulse strategy for a Lagrangian collision over collided edges, limiting the maximum number of detections per strand to avoid numerical bottlenecks.

### Hair-Solid Collisions

Finally, the strand dynamics module 204 resolves any hair-solid collisions (block 416). The last step of an iteration corresponds to final velocity and position corrections to account for solid collision responses. Having a precomputed SDF σ_{head}: [symbol] ³→ [symbol] of the head, with an associated velocity field ν_{head}: [symbol] ³→ [symbol] ³, strand dynamics module 204 checks for particles that will be updated into an invalid position σ_{head}(x+Δtv)<0. For these cases, the strand dynamics module 204 updates the velocity by:

$${v}^{′} = {v}_{head} + max ( 0 , 1 - μ \frac{‖ {v}_{N} - {v}_{hea {d}_{N}} ‖}{‖ {v}_{T} - {v}_{hea {d}_{T}} ‖} ) ( {v}_{T} - {v}_{hea {d}_{T}} ) , \qquad ( 16 )$$

where ν_{head}=ν_{head}(x+Δtv), and the sub-indices N and T denote the normal and tangential components of velocities when projected on the level-set normal ∇σν_{head}(x+Δtv). When the targeted positions of particles are still inside of the head, the strand dynamics module 204 pushes them further in a second stage by setting:

$${x}^{′} = x + ( \frac{∇ {σ}_{head}}{‖ ∇ {σ}_{head} ‖} {σ}_{head} ) ( x + Δ t {v}^{´} ) . \qquad ( 17 )$$

To simulate progressive hair damage and the loss of global shape features due to intense elongation provoked by motion or external forces, the strand dynamics module 204 incorporates non-Hookean effects in the augmented mass-spring system. As detailed before, global stiffness is encoded in the described model via the gravity part of the biphasic coupling. In addition, physical hair strands produce non-linear stress-strain curves. Considering this, the strand dynamics module 204 directly parametrizes the experimental curve for dry hair and sets the gravity tension T_{g} to its proportional value according to its elongation.

FIG. 5 depicts multiple example implementations 500 for simulating digital hair dynamics using a conventional mass-spring system and the described augmented mass-spring system. In particular, a time evolution, from left to right, of long hair blowing in the wind is simulated using a conventional mass-spring model 502 and the described augmented mass-spring model 504.

At initialization (image 506), the conventional mass-spring model's simulation experiences severe sagging, losing the overall shape of the hairstyle. As a result, the subsequent simulations (images 508 and 510) of this mass-spring model do not maintain the global geometry features of the input hairstyle.

In contrast, the augmented mass-spring model avoids excessive sagging and maintains the overall shape of the input hairstyle at initialization (image 512). The augmented mass-spring model can also capture vivid dynamics of hair blowing in the wind (images 514 and 516) while preserving the overall geometry features of the hairstyle.

The hair simulation service 116 enables four main types of user interactions for digital simulations: linear transforming, grabbing (e.g., of a subset of the hair strands), trimming (e.g., of the hair model or a portion thereof), and procedural hair growth on the head mesh. Because the augmented mass-spring system handles simulation at the strand level, linear transforming input assets (e.g., uniform scaling, moving, and rotation) is straightforward and performed over discretized particles. Grabbing and trimming are executed using spring-like forces and cutting planes within a selection radius.

The algorithm for procedural growth is divided into two stages. First, given a pre-selected set of triangles in the mesh, pₙ random root positions are sampled per triangle. Then, the hair simulation service 116 computes the initial strand direction

$${p}_{dir}^{0}$$

on each position by weighting the per-vertex normal vectors of the root using its barycentric coordinates and adding a noise vector with entries from the distribution [symbol] (−1,1).

During the second stage, the hair simulation service 116 adds sequential vertices to the strand, starting from the root. Specifically, the hair simulation service 116 computes:

$${p}_{dir}^{{t}^{`}} = {p}_{dir}^{i - 1} + {p}_{grav}^{i - 1} max ( {p}_{Γ} , 1 - ‖ {p}_{d i r}^{i - 1} \cdot ( 0 , 1 , 0 ) ‖ ) , \qquad ( 18 )$$

where p_{Γ} fixes the maximum particle deviation, and the procedural vector

$${p}_{grav}^{i}$$

accounts for strand changes in the vertical direction, and is defined as:

$${p}_{grav}^{i} = ( 0 , - 0.891 i {p}_{γ} , 0 ) , \qquad ( 19 )$$

with gravity influence parameter p_{γ}. Then, to incorporate curls into the procedural growth module, the hair simulation service 116 performs an additional update step:

$${p}_{dir}^{i} = {p}_{dir}^{{i}^{`}} + {p}_{Ω} ( {p}_{dir}^{{i}^{`}} - {H}^{i} ) , \qquad ( 20 )$$

with spiral impact factor p_{Ω}, and helix vector Hⁱ described by:

$${H}^{i} = ( {p}_{h} cos ( i {p}_{freq} ) , 1 , {p}_{h} sin ( i {p}_{freq} ) ) , \qquad ( 21 )$$

with helix radius pₕ.

### Example Hair Simulation Procedures

The following discussion describes hair simulation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm, e.g., responsive to execution of the instructions. In portions of the following discussion, reference will be made to FIGS. 1-5.

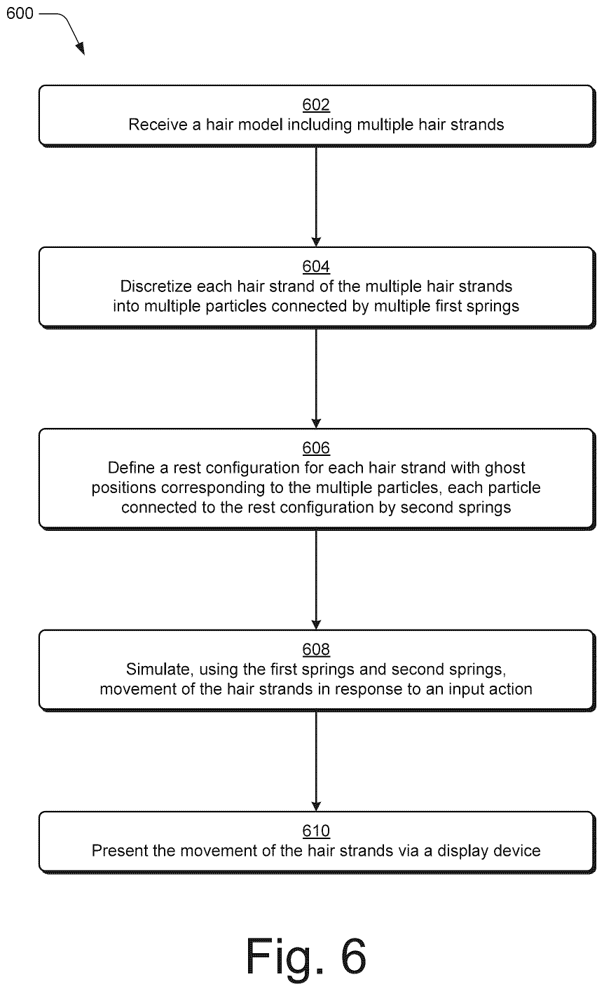

FIG. 6 is a flow diagram depicting an algorithm as a step-by-step procedure 600 in an example implementation of operations performable for accomplishing digital hair simulation using an augmented mass-spring system. To begin in this example, a processing device receives a hair model that includes multiple hair strands (block 602). The hair model provides a digital representation of a hairstyle.

The processing device discretizes each hair strand of the multiple hair strands into multiple particles connected by multiple first springs (block 604). For example, the first springs provide edge, bending, and torsional degrees of freedom. The processing device also defines an initial or rest configuration for each hair strand with ghost positions corresponding to the multiple particles (block 606). In other words, the ghost positions indicate the initial position of each particle in the discretized hair strands. Each particle is connected to the rest configuration by second springs.

In response to an input action, the processing device simulates the movement of the hair strands using the first springs and second springs (block 608). For example, the input action includes head motion, external forces, grabbing, trimming, and procedural hair growth. The simulated movement of the hair strands is then presented via a display device (block 610).

### Example System and Device

FIG. 7 illustrates an example system 700 that includes an example computing device 702 that is representative of one or more computing systems and/or devices usable to implement the various techniques described herein. This is illustrated through the inclusion of the hair simulation service 116. The computing device 702 is configurable, for example, as a server of a service provider, a device associated with a client (e.g., a client device), an on-chip system, and/or any other suitable computing device or computing system.

The example computing device 702, as illustrated, includes a processing system 704, one or more computer-readable media 706, and one or more I/O interfaces 708 that are communicatively coupled, one to another. Although not shown, the computing device 702 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing system 704 is representative of the functionality to perform one or more operations using hardware. Accordingly, the processing system 704 is illustrated as including hardware elements 710 that are configured as processors, functional blocks, and so forth. This includes example implementations in hardware as an application specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. Memory/storage 712 represents memory or storage capacity associated with one or more computer-readable media. In one example, the memory/storage 712 includes volatile media (such as random access memory (RAM)) and/or nonvolatile media (such as read-only memory (ROM), Flash memory, optical disks, magnetic disks, and so forth). In another example, the memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways, as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 702, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 710. For example, the computing device 702 is configured to implement particular instructions and/or functions corresponding to the software and/or hardware modules. Accordingly, implementation of a module that is executable by the computing device 702 as software is achieved at least partially in hardware, e.g., through the use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supportable by various configurations of the computing device 702 and are not limited to the specific examples of the techniques described herein. This functionality is also implementable entirely or partially through the use of a distributed system, such as over a “cloud” 714, as described below.

The cloud 714 includes and/or is representative of a platform 716 for resources 718. The platform 716 abstracts the underlying functionality of hardware (e.g., servers) and software resources of the cloud 714. For example, the resources 718 include applications and/or data utilized while computer processing is executed on servers remote from the computing device 702. In some examples, the resources 718 also include services provided over the Internet and/or through a subscriber network, such as a cellular or Wi-Fi network.

The platform 716 abstracts the resources 718 and functions to connect the computing device 702 with other computing devices. In some examples, the platform 716 also serves to abstract scaling of resources to provide a corresponding level of scale to encountered demand for the resources implemented via the platform. Accordingly, in an interconnected device embodiment, the implementation of functionality described herein is distributable throughout the system 700. For example, the functionality is implementable in part on the computing device 702 as well as via the platform 716 that abstracts the functionality of the cloud 714.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, a hair model including multiple hair strands;
discretizing, by the processing device, each hair strand of the multiple hair strands into multiple particles connected by first springs;
defining, by the processing device, a rest configuration for each hair strand with ghost positions corresponding to an initial position of the multiple particles, each particle of the multiple hair strands being connected to the rest configuration by second springs;
simulating, by the processing device using the first springs and the second springs, movement of the multiple hair strands in response to an input action; and
presenting the movement of the multiple hair strands via a display device.

2. The method of claim 1, wherein the second springs include:
gravity springs connecting each particle of the multiple particles to a corresponding ghost position; and
angular springs connecting a particle of a hair strand with a subsequent ghost position, the subsequent ghost position being the corresponding ghost position of a next particle moving from the particle toward a tip of the hair strand.

3. The method of claim 2, wherein each gravity spring has an initial length of zero and a tension proportional to a distance between each particle and the corresponding ghost position.

4. The method of claim 3, wherein a material stiffness of each hair strand is proportional to an average spring constant for the gravity springs of the hair strand.

5. The method of claim 4, wherein a value of a spring constant for the gravity springs of each hair strand linearly deceases as a function of a distance of the particle from a root of the hair strand.

6. The method of claim of claim 3, wherein the tension of each gravity spring is set to incorporate non-linear stress-strain curves of hair strands.

7. The method of claim 2, wherein each angular spring has a tension proportional to an angle between a first segment and a second segment, the first segment defined by a first line between the particle and the next particle, the second segment defined by a second line between the particle and the corresponding ghost position of the next particle.

8. The method of claim 1, wherein the first springs are two-way springs and the second springs are one-way springs.

9. The method of claim 1, wherein the input action includes head motion, external forces, grabbing of a subset of the multiple hair strands, trimming of the hair model, or growth of the multiple hair strands.

10. The method of claim 1, wherein the multiple first springs include:
edge springs connecting adjacent particles of each hair strand;
bending springs connecting particles separated by a single particle along each hair strand; and
torsional springs connecting particles separated by two particles along each hair strand.

11. The method of claim 1, wherein a quantity of the multiple particles for each hair strand equals a number equal to or between fifteen and twenty particles.

12. The method of claim 1, wherein simulating the movement of the multiple hair strands comprises:
initializing a position and velocity of the multiple particles of each hair strand;
determining, based on the first springs and the second springs, an updated velocity at multiple time intervals for the multiple particles in response to an external force caused by the input action; and
determining, based on the updated velocity, an updated position at the multiple time intervals for the multiple particles of each hair strand.

13. The method of claim 12, wherein:
each time interval of the multiple time intervals includes multiple intermediate time intervals; and
simulating the movement of the multiple hair strands further comprises for each intermediate time interval comprises:
determining, based on the first springs and the second springs, an intermediate updated velocity at each intermediate time interval for the multiple particles in response to the external force; and
determining, based on the intermediate updated velocity, an intermediate updated position at the intermediate time interval for the multiple particles.

14. The method of claim 13, wherein simulating the movement of the multiple hair strands further comprises:
determining, based on inextensibility constraints applied to the updated velocity and the updated position, a first modified velocity and a first modified position of the multiple particles of each hair strand at each time interval; and
determining, based on self interactions of the multiple hair strands and collisions with solid objects, a second modified velocity and a second modified position of the multiple particles of each hair strand at each time interval as the updated velocity and the updated position for each time interval.

15. A computing device comprising:
a processing device; and
a computer-readable medium storing instructions that, in response to execution by the processing device, cause the processing device to perform operations including:
receive a hair model including multiple hair strands;
discretize each hair strand of the multiple hair strands into multiple particles connected by first springs, each first spring being a two-way spring;
define a rest configuration for each hair strand with ghost positions corresponding to an initial position of the multiple particles, each particle of the multiple hair strands being connected to the rest configuration by second springs, each second spring being a one-way spring;
simulate, using the first springs and the second springs, movement of the multiple hair strands in response to an input action; and
present the movement of the multiple hair strands via a display device.

16. The computing device of claim 15, wherein:
the first springs include edge springs connecting adjacent particles of each hair strand, bending springs connecting particles separated by a single particle along each hair strand, and torsional springs connecting particles separated by two particles along each hair strand; and
the second springs include:
gravity springs connecting each particle of the multiple particles to a corresponding ghost position; and
angular springs connecting a particle of a hair strand with a subsequent ghost position, the subsequent ghost position being the corresponding ghost position of a next particle moving from the particle toward a tip of the hair strand.

17. The computing device of claim 16, wherein:
each gravity spring has an initial length of zero and a tension proportional to a distance between each particle and the corresponding ghost position; and
each angular spring has a tension proportional to an angle between a first segment and a second segment, the first segment defined by a first line between the particle and the next particle, the second segment defined by a second line between the particle and the corresponding ghost position of the next particle.

18. The computing device of claim 17, wherein a material stiffness of each hair strand is proportional to an average spring constant for the gravity springs of the hair strand.

19. The computing device of claim 15, wherein simulating the movement of the multiple hair strands comprises:
initializing a position and velocity of the multiple particles of each hair strand;
determining, based on the first springs and the second springs, an updated velocity at multiple time intervals for the multiple particles in response to an external force caused by the input action; and
determining, based on the updated velocity, an updated position at the multiple time intervals for the multiple particles of each hair strand.

20. One or more computer-readable media storing instructions that, responsive to execution by a processing device, causes the processing device to perform operations comprising:
receiving a hair model including multiple hair strands;
discretizing each hair strand of the multiple hair strands into multiple particles connected by first springs;
defining a rest configuration for each hair strand with ghost positions corresponding to an initial position of the multiple particles, each particle of the multiple hair strands being connected to the rest configuration by second springs;
simulating, using the first springs and the second springs, movement of the multiple hair strands in real-time in response to an input action; and
presenting the movement of the multiple hair strands via a display device.
